(19) United States
(12) Patent Application Publication
(10) Pub. No.: US 2011/0139952 A1
(43) Pub. Date: Jun. 16, 2011

(54) BRACKET FOR DATA STORAGE DEVICE

(75) Inventors: CHUN-WEI CHANG, Tu-Cheng (TW); JUI-FENG HU, Tu-Cheng (TW); CHANG-JU WU, Tu-Cheng (TW)

(73) Assignee: HON HAI PRECISION INDUSTRY CO., LTD., Tu-Cheng (TW)

(21) Appl. No.: 12/647,433

(22) Filed: Dec. 25, 2009

(30) Foreign Application Priority Data
Dec. 11, 2009 (TW) 98142458

(51) Int. Cl. F16M 13/00

(52) U.S. Cl. 248/309.1

(57) ABSTRACT

A bracket for mounting a data storage device thereon includes a holding frame and an operating structure. The holding frame includes a substrate and first and second sidewalls extending from two opposite sides of the substrate. A receiving space is defined in the holding frame for receiving the data storage device therein. The operating structure is mounted to the first sidewall and includes an active member and a passive member connected with the active member. The active member defines a receiving groove for receiving one side of the data storage device therein. The passive member defines a sliding groove for receiving one end of the active member therein. The active member is slideable in the sliding groove of the passive member. The passive member is slideable along the first sidewall.

### BACKGROUND

1. Technical Field

The present disclosure generally relates to mounting devices, and more particularly to a bracket for mounting a data storage device of a computer thereon.

2. Description of Related Art

With development in computer technology, computers have become an indispensable part of our daily life. In a computer, a data storage device is needed for storing data and information. The data storage device may include a hard disk drive, an optical disk drive, etc.

The data storage device generally is mounted on a bracket via screws and the bracket is then mounted in the computer. In repairing and maintaining the data storage device, the data storage device is required to detach from the bracket. After the data storage device is repaired, the data storage device is again mounted back to the bracket. However, it is inconvenient and time-consuming to detach the data storage device from the bracket or mount the data storage device back to the bracket since the data storage device is mounted to the bracket by screws.

What is needed, therefore, is a bracket for data storage device to overcome the above described shortcoming.

### BRIEF DESCRIPTION OF THE DRAWINGS

FIG. 1 is an isometric, assembled view of a bracket with a data storage device mounted thereon according to an exemplary embodiment of the present disclosure.

FIG. 2 is an exploded view of the bracket and the data storage device of FIG. 1.

FIG. 3 is similar to FIG. 2, but viewed from another viewpoint.

FIG. 4 is an isometric view of an operating structure of the bracket of FIG. 1.

FIG. 5 shows the data storage device being partially drawn out from the bracket of FIG. 1.

FIG. 6 shows the data storage device being completely drawn out from the bracket of FIG. 1.

FIG. 7 is similar to FIG. 6, but viewed from another viewpoint.

FIG. 8 is shows the data storage device being detached from the bracket after the data storage device is completely drawn out from the bracket of FIG. 1.

### DETAILED DESCRIPTION

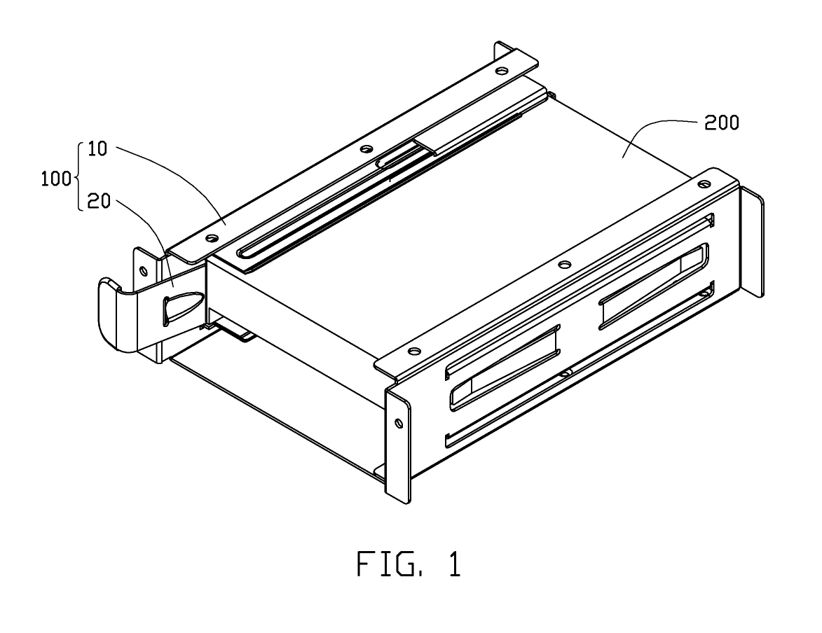

Referring to FIG. 1, a bracket 100 for mounting a data storage device 200 thereon according to an exemplary embodiment of the present disclosure is shown. The bracket 100 is to be installed in an enclosure (not shown) of a computer. The data storage device 200 may be a hard disk drive or an optical disk drive. The bracket 100 includes a holding frame 10 and an operating structure 20 connected with the holding frame 10. The data storage device 200 is supported on the holding frame 10.

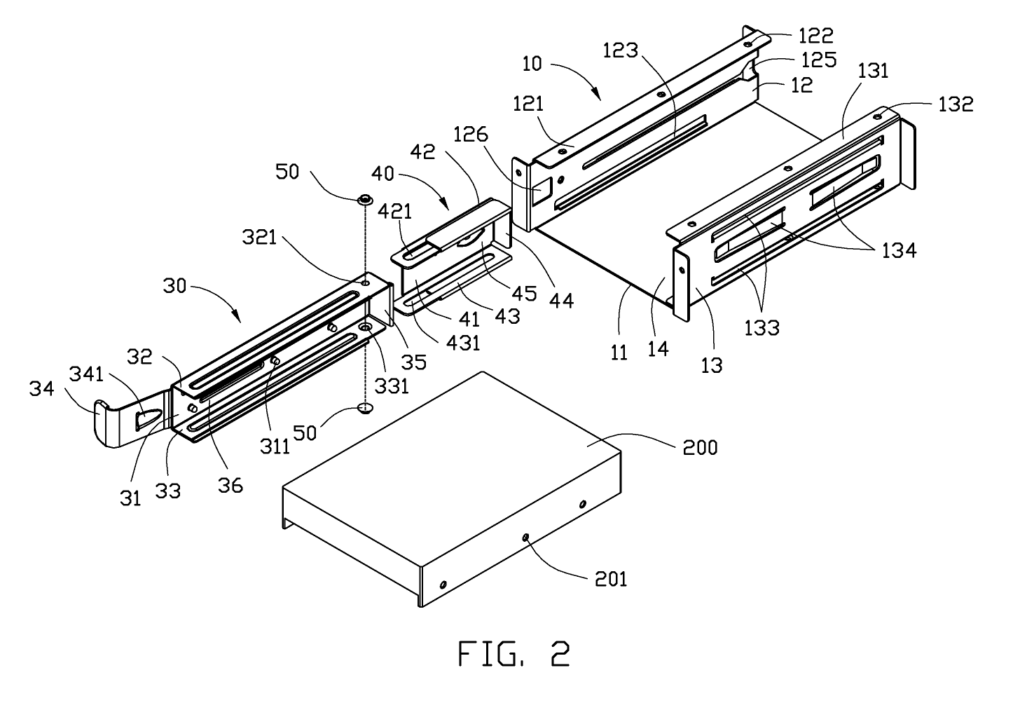

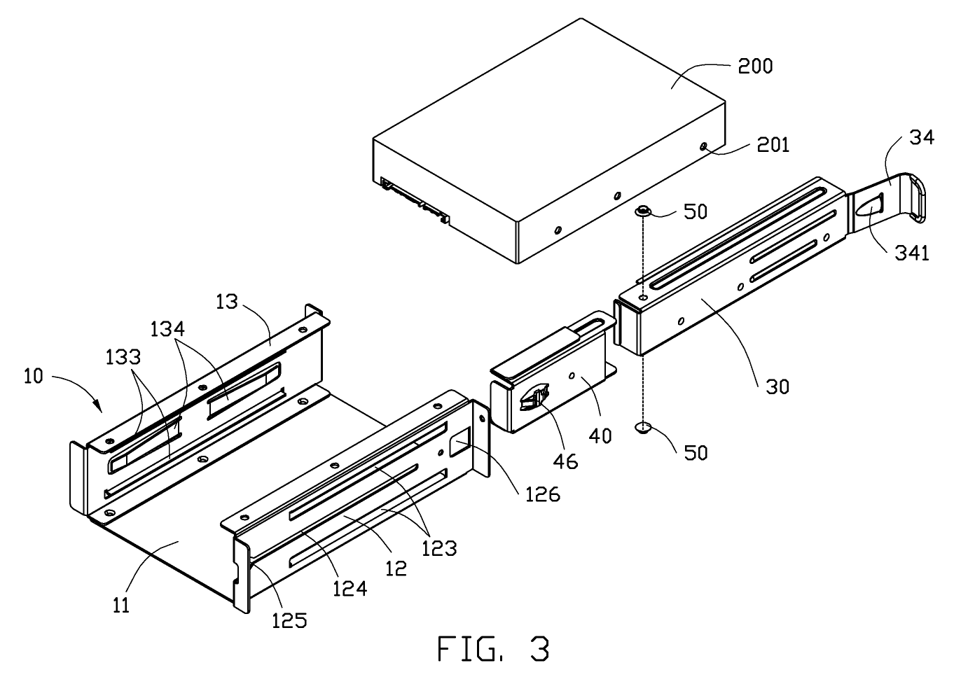

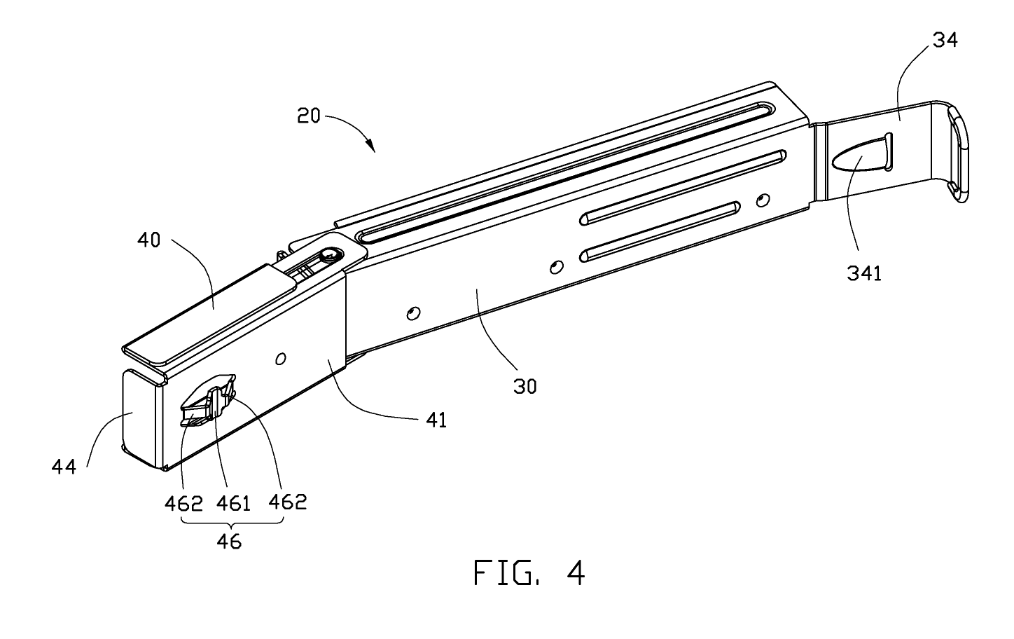

Referring to FIGS. 2-4, the data storage device 200 is rectangular and defines a plurality of mounting holes 201 at each of two opposite lateral sides thereof. The holding frame 10 has a U-shaped cross section and includes a rectangular substrate 11, and first and second sidewalls 12, 13 extending perpendicularly and upwardly from two opposite lateral sides of the substrate 11. A receiving space 14 is defined in the holding frame 10 among the substrate 11 and the sidewalls 12, 13 for receiving the data storage device 200 therein. A top of each of the sidewalls 12, 13 extends horizontally and inwardly towards the receiving space 14 to form a flange 121, 131. Each flange 121, 131 is defined with a plurality of mounting holes 122, 132 therein for securing the holding frame 10 in the enclosure of the computer.

A pair of first guiding plates 123 extend horizontally and inwardly from an inner surface of the first sidewall 12 towards the receiving space 14. The first guiding plates 123 are located between the substrate 11 and the flange 121. The first guiding plates 123 are parallel to the substrate 11 and spaced from each other. A guiding slot 124 is defined in the first sidewall 12 between the first guiding plates 123. The guiding slot 124 is parallel to the first guiding plates 123. An entrance opening 125 is provided at a rear end of the first sidewall 12 and communicated with the guiding slot 124. The entrance opening 125 has a size greater than a width of the guiding slot 124. A locking hole 126 is provided at a front end of the first sidewall 12.

A pair of second guiding plates 133 extend horizontally and inwardly from an inner surface of the second sidewall 13 towards the receiving space 14. The second guiding plates 133 are located between the substrate 11 and the flange 131. The second guiding plates 133 are parallel to the substrate 11 and spaced from each other. Two resilient tabs 134 are provided on the second sidewall 13 between the second guiding plates 133. The two resilient tabs 134 are located at front and rear ends of the second sidewall 13, respectively.

The operating structure 20 is mounted to the first sidewall 12 and slideable relative to the first sidewall 12 between the first guiding plates 123. The operating structure 20 includes an active member 30 and a passive member 40 connected with the active member 30.

The active member 30 includes an abutting plate 31 and top and bottom supporting plates 32, 33 extending horizontally and inwardly from top and bottom sides of the abutting plate 31, respectively. The abutting plate 31 is parallel to the first sidewall 12 of the holding frame 10. The abutting plate 31 and the supporting plates 32 cooperatively form a receiving groove 36 in the active member 20 for receiving a left side of the data storage device 200 therein. A plurality of mounting poles 311 corresponding to the mounting holes 201 of the data storage device 200 is formed on an inner surface of the abutting plate 31 and extends into the receiving groove 36. A handle 34 is connected at a front end of the abutting plate 31. The handle 34 is tilted slightly outwardly away from the active member 30 for facilitating operating. A locking tab 341 is formed on the handle 34 corresponding to the locking hole 126 of the first sidewall 12 of the holding frame 10. A stopping plate 35 is formed at a rear end of the abutting plate 31. The stopping plate 35 extends inwardly from the abutting plate 31. The stopping plate 35 is perpendicular to and connected between the supporting plates 32, 33 of the active member 30. A mounting hole 321, 331 is defined in a rear end of each supporting plate 32, 33.

The passive member 40 includes a side plate 41 and top and bottom connecting plates 42, 43 extending horizontally and inwardly from top and bottom sides of the side plate 41, respectively. The side plate 41 is parallel to the first sidewall 12 of the holding frame 10. The side plate 41 and the connecting plates 42, 43 cooperatively form a sliding groove 45 in the passive member 40 for receiving a rear end of the active member 30 therein. A stopping plate 44 is formed at a rear end of the side plate 41 and extends inwardly from the side plate 41. The stopping plate 44 is perpendicular to and connected between the connecting plates 42, 43 of the passive member 40. A guiding block 46 is formed on an outer surface of the side plate 41 corresponding to the guiding slot 124 of the first sidewall 12. The guiding block 46 includes a central stopping tab 461 and two connecting ribs 462 provided at two opposite sides of the stopping tab 461 and connecting the stopping tab 461 with the side plate 41 of the passive member 40.

A sliding slot 421, 431 is defined in each connecting plate 42, 43. The sliding slot 421, 431 extends from a front end to a rear end of each connecting plate 42, 43. Two fasteners 50 extend through the two sliding slots 421, 431 and are mounted to the mounting holes 321, 331 of the supporting plates 32, 33 of the active member 30. The rear end of the active member 30 is received in the sliding groove 45 of the passive member 40. The fasteners 50 each have an outer diameter slightly smaller than a width of the sliding slot 421, 431. The fasteners 50 can slide in the sliding slot 421, 431 to cause the rear end of the active member 30 to be slideable in the sliding groove 45 of the passive member 40. The active member 30 is pivotally connected to the passive member 40 via the fasteners 50. The active member 30 can be pivoted outwardly relative to the passive member 40 around the fasteners 50.

When the operating structure 20 is mounted to the holding frame 10, the guiding block 46 of the passive member 40 enters into the guiding slot 124 of the first sidewall 12 from the entrance opening 125, such that the guiding block 46 can slide in the guiding slot 124. The connecting ribs 462 of the guiding block 46 are received in the guiding slot 124. The stopping tab 461 is located outside and abuts on an outer surface of the first sidewall 12, with the first sidewall 12 being sandwiched between the stopping tab 461 and the side plate 41 of the passive member 40. The passive member 40 is located between and slideable along the first guiding plates 123 of the first sidewall 12.

When the data storage device 200 is mounted to the holding frame 10, the passive member 40 slides along the first guiding plates 123 to the front end of the first sidewall 12. The fasteners 50 slide along the sliding slots 421 to the front end of the connecting plates 42, 43, such that the active member 30 is connected to a front end of the passive member 40. The active member 30 is located entirely outside the holding frame 10. The mounting poles 311 of the active member 30 are aligned with and inserted in the mounting holes 201 of the left side of the data storage device 200. The left side of the data storage device 200 is received in the receiving groove 36 of the active member 30. Then, the active member 30 and the data storage device 200 are together pushed to move towards the receiving space 14 of the holding frame 10. As the active member 30 and the data storage device 200 are pushed towards the receiving space 14 of the holding frame 10, the rear end of the active member 30 slides in the sliding groove 45 of the passive member 40 until the stopping plate 35 of the active member 30 is brought into contact with the stopping plate 44 of the passive member 40 and a right side of the data storage device 200 is brought to enter into a space between the second guiding plates 133 of the second sidewall 13. As the active member 30 and the data storage device 200 are further pushed to move into the receiving space 14 of the holding frame 10, the right side of the data storage device 200 slides along the second guiding plates 133 of the second sidewall 13 towards a rear end of the second sidewall 13. The stopping plate 35 of the active member 30 pushes the stopping plate 44 of the passive member 40, whereby the passive member 40 is pushed by the active member 30 to slide along the first guiding plates 13 of the first sidewall 12 towards the rear end of the first sidewall 12. When the passive member 40 reaches to the rear end of the first sidewall 12, the data storage device 200 is completely received in the receiving space 14 of the holding frame 10. The locking tab 341 of the active member 30 is locked in the locking hole 126 of the first sidewall 12, and the resilient tabs 134 of the second sidewall 13 resiliently abut against the right side of the data storage device 200, thereby firmly mounting the data storage device 200 in the receiving space 14 of the holding frame 10, as shown in FIG. 1.

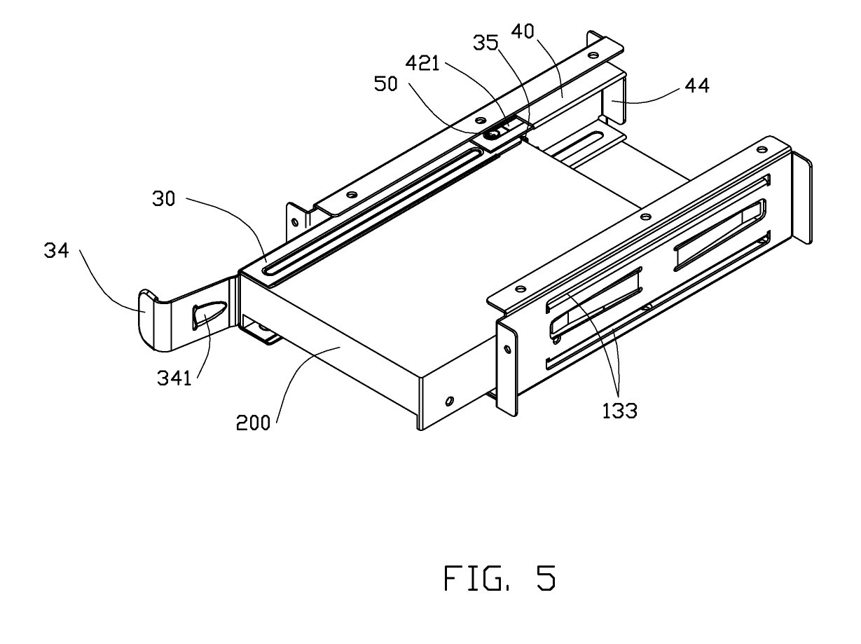

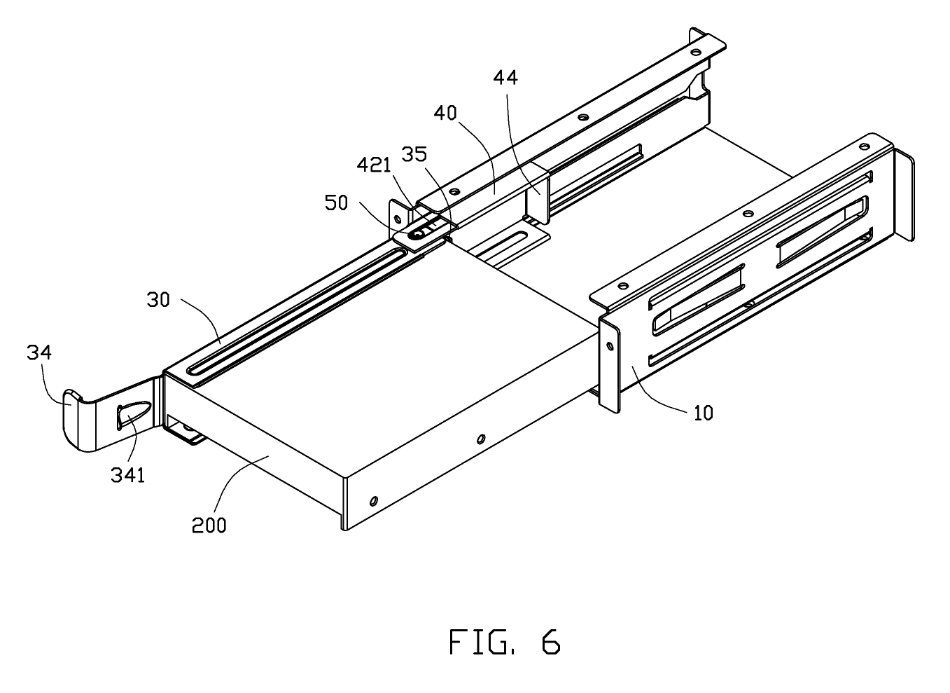

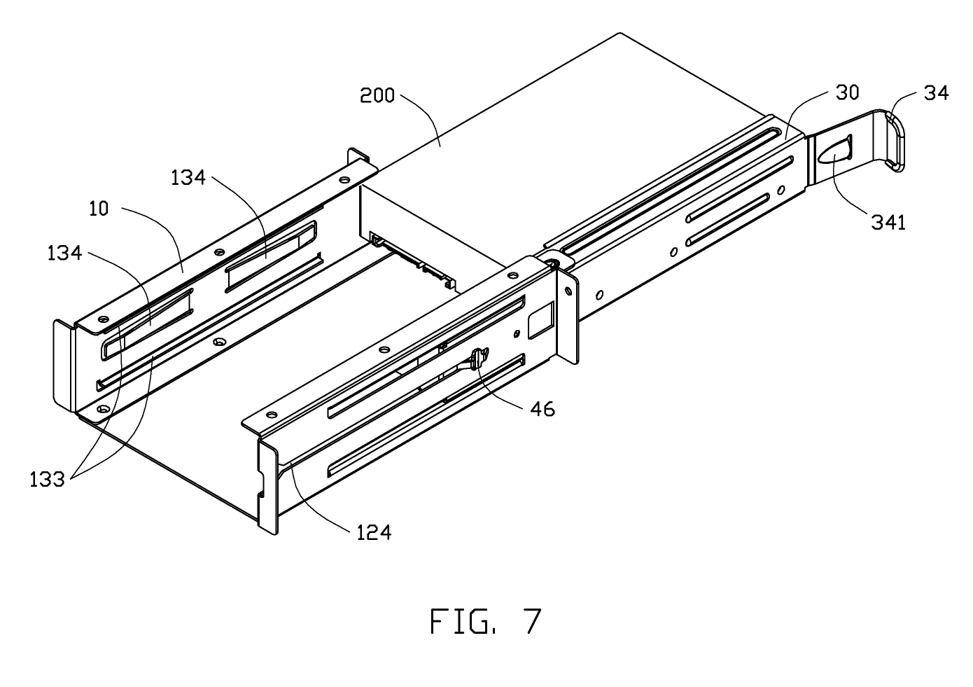

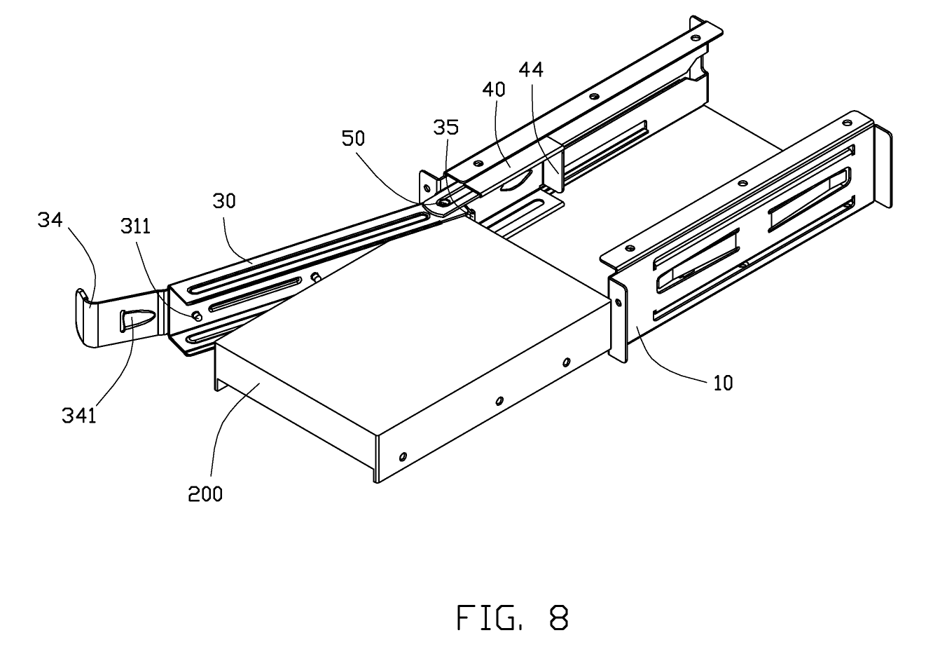

Referring to FIGS. 5-8, when the data storage device 200 is detached from the holding frame 10, the locking tab 341 of the active member 30 is caused to disengage from the locking hole 126 of the first sidewall 12 and then the data storage device 200 and the active member 30 are pulled forwards. The rear end of the active member 30 slides forwards along the sliding groove 45 of the passive member 40 and the right side of the data storage device 200 slides along the second guiding plates 133 of the second sidewall 13 towards the front end of the second sidewall 13, as shown in FIG. 5. As the data storage device 200 and the active member 30 are further pulled forwards, the passive member 40 is pulled by the active member 30 and slides forwards along the first guiding plates 123 to the front end of the first sidewall 12 and the right side of the data storage device 200 slides out the second guiding plates 133 from the front end of the second sidewall 13, as shown in FIGS. 6-7. At this stage, the data storage device 200 and the active member 30 are entirely located outside the receiving space 14 of the holding frame 10. Thereafter, the active member 30 is outwardly rotated relative to the passive member 40 around the fasteners 50 to cause the mounting poles 311 of the active member 30 to disengage from the mounting holes 201 of the data storage device 200. Finally, the data storage device 200 is removed away from the active member 30 of the operating structure 20. In the present bracket 100, the data storage device 200 can be mounted to or detached from the holding frame 10 conveniently by pushing the operating structure 20 into the holding frame 10 or drawing the operating structure 20 out from the holding frame 10.

It is to be understood, however, that even though numerous characteristics and advantages of the disclosure have been set forth in the foregoing description, together with details of the structure and function of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A bracket for mounting a data storage device thereon, comprising:
a holding frame adapted for supporting the data storage device thereon, the holding frame comprising a substrate and first and second sidewalls extending from two opposite sides of the substrate, a receiving space being defined in the holding frame among the substrate and the sidewalls for receiving the data storage device therein; and
an operating structure mounted to the first sidewall of the holding frame and comprising an active member and a passive member connected with the active member, the active member defining a receiving groove for receiving one side of the data storage device therein, the passive member defining a sliding groove for receiving one end of the active member therein, the active member being slideable in the sliding groove of the passive member, the passive member being slideable along the first sidewall of the holding frame.

2. The bracket of claim 1, wherein the active member comprises an abutting plate and top and bottom supporting plates extending from top and bottom sides of the abutting plate, respectively, and the receiving groove is defined among the abutting plate and the supporting plates.

3. The bracket of claim 2, wherein a plurality of mounting poles are formed on the abutting plate towards the receiving groove, and the mounting poles are operable to be inserted in a plurality of mounting holes defined in the one side of the data storage device received in the receiving groove of the active member.

4. The bracket of claim 1, wherein the passive member comprises a side plate and top and bottom connecting plates extending from top and bottom sides of the side plate, respectively, and the sliding groove is defined among the side plate and the connecting plates.

5. The bracket of claim 4, wherein a sliding slot is defined in each connecting plate, the sliding slot extends from a front end to a rear end of each connecting plate, the active member is coupled to the passive member such that the active member is slideable in the passive member along the sliding slot.

6. The bracket of claim 5, wherein a fastener extends through the sliding slot and is mounted to the active member, the fastener slides in the sliding slot to cause the active member to be slideable in the sliding groove of the passive member.

7. The bracket of claim 6, wherein the active member is pivotally connected to the passive member via the fastener.

8. The bracket of claim 4, wherein a guiding slot is defined in the first sidewall of the holding frame, a guiding block is formed on the side plate corresponding to the guiding slot, and the guiding block is slideable in the guiding slot.

9. The bracket of claim 1, wherein the first sidewall is formed with two guiding plates, the guiding plates extend from an inner surface of the first sidewall towards the receiving space, and the passive member is slideable along the guiding plates of the first sidewall from a front end to a rear end of the first sidewall.

10. The bracket of claim 1, wherein the second sidewall is formed with two guiding plates, the guiding plates extend from an inner surface of the second sidewall towards the receiving space, and the guiding plates are adapted for slideably supporting another side of the data storage device thereon.

11. The bracket of claim 10, wherein at least one resilient tab is formed on the inner surface of the second sidewall, the at least one resilient tab is located between the guiding plates, and the at least one resilient tab is adapted for resiliently abutting against the another side of the data storage device.

12. The bracket of claim 1, wherein a locking tab is formed on the active member, a locking hole is defined in the first sidewall, and the locking tab is locked in the locking hole when the data storage device is mounted in the receiving space of the holding frame.
